(19) United States
(12) Patent Application Publication
(10) Pub. No.: US 2026/0244537 A1
(43) Pub. Date: Aug. 20, 2026

(54) BOOT FAILURE EVENT DETECTION AND RECOVERY TECHNIQUES BY BASEBOARD MANAGEMENT CONTROLLER

(71) Applicant: Hewlett Packard Enterprise Development LP, Spring, TX (US)

(72) Inventor: Suhas Shivanna, Houston, TX (US)

(21) Appl. No.: 19/058,856

(22) Filed: Feb. 20, 2025

(51) Int. Cl. G06F 11/14; G06F 11/07; G06F 11/1482

(52) U.S. Cl. CPC G06F 11/1433; G06F 11/0757; G06F 11/0772; G06F 11/1417; G06F 11/1438; G06F 11/1482

(57) ABSTRACT

A method for performing recovery operations in response to detecting a boot failure event may include detecting, via a controller, a boot failure event associated with a computing device. The method may also involve querying a database to identify a set of recovery operations that may include one or more scripts associated with recovering from the boot failure event. The database may include a plurality of sets of recovery operations associated with a plurality of boot failure events. The method may then involve retrieving an image based on the set of recovery operations and executing the one or more scripts. The one or more scripts may cause the computing device to return to a previous state.

### BACKGROUND

Service providers and manufacturers are challenged to deliver quality and value to consumers, for example by providing computing devices with management controllers. Management controllers can be used to control management of various functionalities of computing devices such as servers. Firmware can be used on such management controllers. Boot events occur for a variety of reasons and may originate from a variety of sources due to a software update, a firmware update, an operating system (OS) error, and the like.

### DRAWINGS

These and other features, aspects, and advantages of the present disclosure will become better understood when the following detailed description is read with reference to the accompanying drawings in which like characters represent like parts throughout the drawings, wherein:

FIG. 1 illustrates an example system that includes a computing device having a baseboard management controller (BMC) that may manage boot failure detection and recovery operations, in accordance with aspects of the present disclosure;

FIG. 2 illustrates an example block diagram of components of the baseboard management controller, in accordance with aspects of the present disclosure;

FIG. 3 illustrates an example block diagram of components of an operating system (OS), in accordance with aspects of the present disclosure;

FIG. 4 illustrates an example block diagram illustrating the baseboard management controller in communication with an operating system (OS), in accordance with aspects of the present disclosure;

FIG. 5 illustrates an example flow chart of a method for detecting and recovering from boot failure events, in accordance with aspects of the present disclosure; and

FIG. 6 illustrates components of a baseboard management controller (BMC) including a processor and computer-readable medium that stores instructions for performing the method of FIG. 5, in accordance with aspects of the present disclosure.

### DETAILED DESCRIPTION

Boot events, such as repeated and continuous boot failures, may occur due to faulty updates, malware, or other sources may disrupt operations for corresponding organizations. These boot events are often difficult to resolve remotely because the affected computing device cannot engage with platform software (e.g., an operating system) to facilitate remote access. As a result, these situations often result in cumbersome recovery processes being deployed by individuals physically accessing the affected machines.

The present disclosure includes using a baseboard management controller (BMC) of a computing device to monitor the installation of software updates, detect updates being implemented by platform software, such as an operating system (OS), of the respective computing device, scan for potential boot failure events, and the like. That is, the BMC may include certain components that may detect a boot failure event that may occur due to an update executed by the platform software and may orchestrate recovery operations related to resolving the detected boot failure event to enable the corresponding computing device to resume operations.

By way of example, the BMC may include an embedded storage component for storing recovery images related to a respective platform software being used by the computing device. The recovery images may be stored in a locally accessible embedded storage component, at a remote storage component that may be downloaded via a communication protocol (e.g., Hypertext Transfer Protocol Secure (HTTPS)), and the like. In some implementations, the recovery image may be a security hardened and stripped-down version of the platform software with embedded software utilities that may execute recovery scripts and facilitate communications between the platform software and the BMC. The recovery image may also include a product, a platform software specific recovery file, or an Operating System (OS) specific recovery file that may include recovery scripts associated with certain software vendors to initiate recovery operations to undo or recover from an update or change implemented by a respective software component. Since the recovery images are accessible to the BMC, the BMC may mount the recovery image as a virtual drive on the system and execute recovery scripts within the recovery image in response to detecting a boot failure event or a continuous boot failure event.

To detect a continuous boot failure event, the BMC may also include a message analyzer component that may process messages sent between the BMC and the platform software via a communication interface. The communication interface between the platform software and the BMC may facilitate the delivery of messages from the platform software to the BMC indicative of a successful platform software boot, an unsuccessful platform software boot, an error in a software component, a reception and successful installation of a software package, and the like. In some implementations, the software package may include an update to a software component, information related to a unique identifier (ID) of a product being updated and a corresponding recovery script to implement for undoing the operations related to the update, and the like. The information with the unique identifier and the corresponding recovery script may be sent to the BMC after a successful update operation. The recovery scripts may override preconfigured recovery scripts previously associated with the corresponding software component in the preconfigured recovery image or the like.

The data within the messages received from the platform software may be stored in a separate storage component accessible to the BMC to serve as a recovery knowledge database. The recovery knowledge database may retain certain platform software messages, recovery operations associated with the platform software , recovery operations associated with various software components, a record of operational states (e.g., successful boot) of the platform software over time, a series of journal entries corresponding to software updates to software components implemented by the platform software (e.g., derived using messages sent from platform software after update), and the like. In this way, the recovery knowledge database may include information regarding updates implemented by the platform software, incorporated into other software components, and the like, such that the information may be used to identify and execute recovery operations for the respective software component in response to detecting a boot failure event, a failure in the execution of the software component, and the like.

In addition to the recovery knowledge database, the BMC may include a boot failure detection engine that may detect boot failure events, the presence of boot failure conditions, and the like. In some implementations, the boot failure detection engine may monitor commands and messages sent by platform software, which may include the operating system, interrupt handlers, a Unified Extensible Firmware Interface (UEFI) stack, and the like, to determine whether certain messages correspond to boot events (e.g., boot failure events). Platform software can be executed by a hardware processor of a computing device. The hardware processor can be separate from the BMC. The boot failure detection engine may review the messages in view of information stored in the recovery knowledge database to determine whether the messages are indicative of a continuous boot failure event or a particular occurrence of a boot failure event.

The BMC may also receive messages related to the operational state of the platform software from the platform software after the occurrence of a boot failure event. In addition, the platform software may send messages indicative of successful boot events. The information concerning boot failure events may indicate a type of failure, a timestamp of the boot failure event, and the like. In this way, the BMC may detect and record different types of boot failure events in the recovery knowledge database, such that the BMC may initiate recovery operations based on previously performed recovery operations for the same type of boot failure events.

Since some boot failure events are associated with software updates, software packages providing the updates may include recovery-related information to assist the BMC in performing recovery operations related to the respective update. The recovery-related information may include a pairing between a product identifier associated with the respective software component and recovery scripts to handle any resulting boot failure events associated with the software component. The recovery scripts may include modifying a configuration of the computing device to disable the software component from executing, commands to delete or modify a registry, and the like. In addition, the recovery scripts may delete the software or execute commands to initiate a rollback of the update to software component, the installation of the software components, and the like. These recovery scripts may be stored as part of the recovery knowledge database, such that the BMC may identify the appropriate recovery operations in response to detecting the failure in the corresponding software component.

In some implementations, the BMC may also include a recovery orchestrator to coordinate recovery operations after the boot failure detection engine detects a boot failure event. The recovery orchestrator may use a message from the boot failure detection engine and information in the recovery knowledge database to determine one or more recovery operations to perform.

On the other hand, if the boot failure event occurs due to a platform software update, the recovery orchestrator may create a backup copy of the current boot order configuration for the computing device and may automatically mount the recovery image associated with a previous state of the platform software. The recovery orchestrator may then implement a recovery script that corresponds to the obtaining the previous state of the platform software as recorded in the recovery knowledge base via the mounted recovery image. After the recovery operations are complete, the BMC may restore the boot order of the platform software to a previous configuration and the computing device or platform software may be rebooted.

In some implementations, the recovery orchestrator may execute different recovery policies for different boot failure events, software errors, or the like. Each policy may dictate the scope of the recovery actions that the recovery orchestrator may perform. That is, the recovery orchestrator may implement a complete recovery (e.g., run recovery scripts for installed software components using the default recovery image) or a failure-based recovery, where the recovery script may be executed for the affected software component or platform software. The failure-based recovery operation may involve identifying the software package or update that caused the downtime based on the recovery knowledge database and performing recovery operations to recover to a previous state prior to the identified software package or update.

Based on the operations of the boot failure detection engine and the recovery orchestrator, as well as the information stored in the recovery database, the BMC may automatically perform recovery operations for various types of failure events, including boot failure events. These recovery operations may be performed by the BMC in response to detecting potential failure events without waiting for remote computing devices to gain external access to the affected computing device. As a result, the BMC may enable the computing device to recover from failure events in an efficient manner, thereby minimizing the inoperable time periods for the respective computing device. Additional details with regard to the BMC monitoring for failure events, storing information related to recovering from different types of failure events, performing recovery operations in response to detecting different types of failure events, and the like will be discussed below.

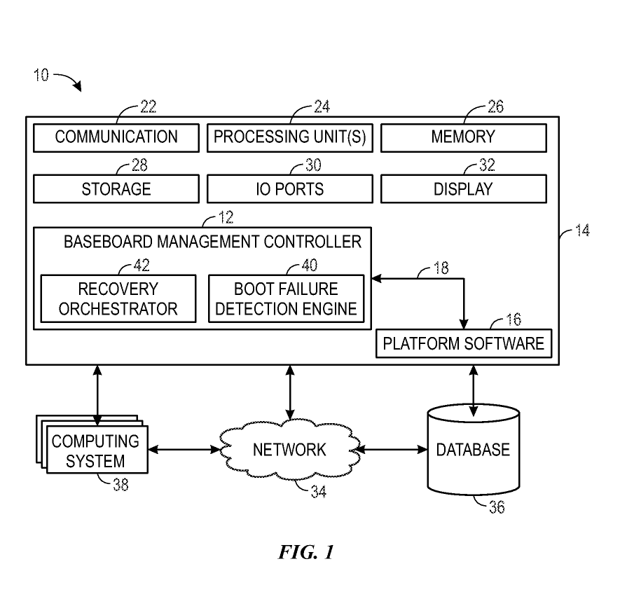

By way of introduction, FIG. 1 illustrates a system 10 in which a baseboard management controller (BMC) 12 may detect boot failure events and perform recovery operations to recover from the boot failure event. Referring to FIG. 1, the BMC 12 may be part of a computing device 14 and may include a processing system that monitors operations of the computing device 14. For instance, the BMC 12 may be part of a motherboard circuitry of the computing device 14 and may include a processing system or processing core to manage operations of the computing device 14. By way of example, the BMC 12 may monitor hardware properties of the computing device 14 via sensors, log event data that may occur on the computing device 14, control power cycling operations of the computing device 14, provide users (e.g., remote) access to the computing device 14, and the like. As such, the BMC 12 may provide control operations to users when other components (e.g., operating system, platform software) are off or unresponsive.

The computing device 14 may include any suitable computing system, such as a desktop computer, a server computer, a laptop computer, a cloud-computing device, and the like. In some implementations, the computing device 14 may include platform software 16 that may be executed via a processing system or the like. The platform software 16 may be implemented via hardware (e.g., electronic circuitry) or a combination of hardware and programming (the combination comprising, e.g., at least one processor and instructions executable by the at least one processor and stored on at least one machine-readable storage medium). By way of operation, the platform software 16 may manage the hardware and software resources of the computing device 14. That is, the platform software 16 may manage memory allocation, execute software applications, provide access to different external components, and the like.

In some implementations, the platform software 16 may communicate with the BMC 12 via a communication interface 18. The communication interface 18 may receive communications or messages from the BMC 12 and deliver them to the platform software 16 and vice versa. As will be discussed in more details below, the platform software 16 may send messages to the BMC 12 related to operating states (e.g., healthy, unhealthy, error detected, boot failure event, successful boot) of the platform software 16, such that the BMC 12 may receive the messages and detect events (e.g., software failures, boot failure events) based on the content of the messages.

In some instances, the computing device 14 may experience a boot failure event or other failure event that may render the computing device 14, portions of the computing device 14, devices connected to the computing device 14, and other suitable components unavailable. For example, the computing device 14 may experience a boot failure event, which may occur when the processing unit 24 or other suitable processing component is unable to detect the platform software 16 to use to boot. The boot failure event may be caused by hardware issues, incorrect Basic Input/Output System (BIOS) settings, software conflicts (e.g., due to software updates), and the like. In a particular example, a software update to a security software designed to protect the platform software 16 from malware and other threats may be incorrectly designed, such that the update may cause a logic error in the execution of the platform software 16. The boot failure event and other computing errors may cause the computing device 14 to become inaccessible and even present the infamous continuous blue screen of death (BSOD).

To more efficiently detect and recover from various types of events that may threaten the functionalities of the computing device 14, the BMC 12 may employ a boot failure detection engine 40 to detect potential events that may cause the computing device 14 to become inaccessible, the platform software 16 to fail to boot, and the like. In addition, the BMC 12 may include a recovery orchestrator 42 that may coordinate the execution of certain recovery operations that may enable the computing device 14 to return to a previous state in which the computing device 14 is accessible and operable again based on the detected event.

The computing device 14 may include a number of components to perform the various operations. For example, the computing device 14 may include a communication component 22, processing units 24, a memory 26, a storage component 28, input/output (IO) ports 30, a display 32, and the like. The communication component 22 may be a wireless or wired communication component that facilitates communication between the computing device 14 and any other suitable electronic device.

Each of the processing units 24 may include multiple processor devices that may be of any type of computer processor or microprocessor capable of executing computer-executable code. Each processing unit 24 may also include multiple processors that may perform the operations described below. The processing units 24 may perform or execute logic functions, computer-readable instructions, and the like.

The memory 26 and the storage component 28 may be any suitable article of manufacture that may serve as media to store processor-executable code, data, or the like. These articles of manufacture may represent computer-readable media (i.e., any suitable form of memory or storage) that may store the processor-executable code used by the processing units 24 to perform the presently disclosed techniques. The memory 26 and the storage component 28 may represent non-transitory computer-readable media (e.g., any suitable form of memory or storage) that may store the processor-executable code used by the processing units 24 to perform various techniques described herein. It should be noted that non-transitory merely indicates that the media is tangible and not a signal.

The IO ports 30 may provide access to the computing systems 38, one or more input devices, one or more displays 32, or the like to facilitate human or machine interaction with the computing device 14. The display 32 may operate to depict visualizations associated with software or executable code being processed by the processing units 24. In some implementations, the display 32 may be a touch display capable of receiving inputs from a user of the computing device 14. The display 32 may be any suitable type of display, such as a liquid crystal display (LCD), plasma display, or an organic light emitting diode (OLED) display, for example. Additionally, in one implementation, the display 32 may be provided in conjunction with a touch-sensitive mechanism (e.g., a touch screen) that may function as part of a control interface for the computing device 14.

As shown in FIG. 1, the system 10 may include a network 34, a database 36, one or more computing systems 38, and the like. The network 34 may include any suitable network that facilitates communication between computing systems, electronic devices, and the like to enable the exchange of data and share resources between each other. The network 34 may include routers, switches, and other traffic directing devices to control the flow of data between senders and recipients. The network 34 may include a wired network, a wireless network, or both. By way of example, the network 34 may include a Local Area Network (LAN), a Wide Area Network (WAN), the Internet, an Intranet, and the like.

The database 36 may be accessible to the computing device 14, the BMC 12, and the like via the network 34, a direct connection, or the like. The database 36 may store recovery images that correspond to different states of the platform software 16, software applications stored on the computing device 14, and the like. As such, the database 36 may serve as external data location for storing data including recovery operations as described herein.

The computing systems 38 may include one or more additional computing devices that may communicate with the computing device 14. In some implementations, the computing systems 38 may include server systems, processing systems, mobile computing devices, remote computing devices, and the like.

Although a certain set of components are depicted with respect to the computing device 14, it should be noted that the computing systems 38 or any other computing or processing device described herein may also include the same or similar components to perform, or facilitate performing, the various operations described herein. Moreover, it should be understood that the components described above are exemplary figures and the computing device 14 and other suitable computing systems may include additional or fewer components as detailed above.

Although FIG. 1 depicts the platform software 16 as being coupled to the BMC 12, it should be noted that any suitable platform software may be coupled to the BMC 12. Indeed, as described below, an example platform system may include an operating system 20 that may manage the operations of the computing device 14.

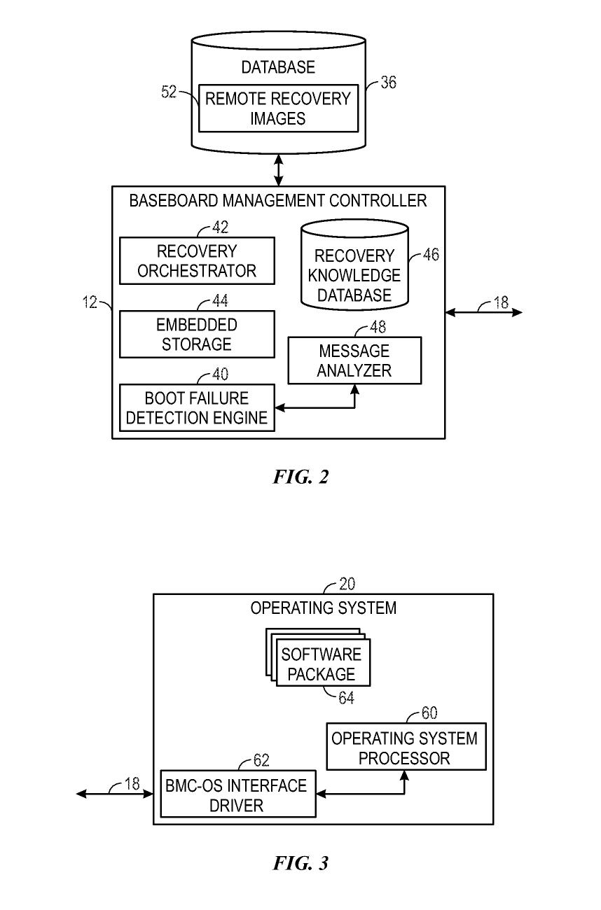

In addition to the boot failure detection engine 40 and the recovery orchestrator 42, the BMC 12 may include embedded storage 44, a recovery knowledge database 46, and a message analyzer 48, as shown in FIG. 2. Referring to FIG. 2, the embedded storage 44 may include any suitable storage device such as a NAND device (e.g., NAND flash devices) and the like. In some implementations, the embedded storage 44 may store recovery images for various types of platform software such as Windows®, Linux®, and the like. In addition, the embedded storage 44 may include journal entries for software updates, platform software changes, and the like, as well recovery related manifests. The recovery images may include manageability tools that may be used to run diagnostic tools and the like to assist in installing the platform software 16.

In some cases in which the embedded storage 44 may be limited in available space, recovery images for the types of platform software 16 may be stored in a remote recovery image repository (e.g., database 36), such that the BMC 12 may be configured at device deployment based on a Uniform Resource Locator (URL) that directs the BMC 12 to the remote recovery image repository. The BMC 12 may download remote recovery images 52 via protocols, such as HTTPS or the like, from the remote recovery image repository storage, which may include the database 36. The BMC 12 may mount the downloaded recovery image as a Virtual Media (VMEDIA) for recovering boot volumes of various types of platform software from boot failure events due to software updates, firmware upgrades, and the like.

Regardless of the location of the recovery images, the recovery images may be a security hardened and stripped-down version of a platform software image (e.g., an operating system image) with embedded core software utilities that may be used to execute recovery scripts and communicate with the BMC 12. The recovery image may also be pre-packaged with product specific recovery files containing recovery scripts for different software vendors, software partners of device manufacturers, and the like. For example, if the recovery for a corrupt software update is possible by running some script, then the recovery file may include a key-value entry that may specify a pairing between a product identifier (e.g., software type) and a corresponding recovery script. The mapping between the product identifier and the recovery script may be used to perform recovery operations for the computing device 14 in response to the boot failure detection engine 40 detecting a boot failure event. In some implementations, the prepackaged recovery image may include software components, such as kernels, drivers, and the like, which may include recovery scripts to allow recovery support for various types of software updates.

After detecting a boot failure event or other suitable event preventing the computing device 14 from operating, the boot failure detection engine 40 may retrieve a recovery image that corresponds to the detected boot failure event from the embedded storage 44. In some implementations, the boot failure detection engine 40 may detect whether a boot process fails based on messages received from the Unified Extensible Firmware Interface (UEFI) stack, which may include a set of software components that enable network communication before the operating system boots. If the boot process fails in the UEFI stack, the boot failure detection engine 40 may use the messages from UEFI stack to determine an error state of the booting process.

In some implementations, the boot failure detection engine 40 may detect boot failure events and other events related to the inoperability of the computing device 14, the platform software 16, or other software components via the message analyzer 48. The message analyzer 48 may be responsible for handling and processing the messages sent by the platform software 16 via the communication interface 18. The communication interface 18 between platform software 16 and the BMC 12 may be any suitable communication interface. By way of operation, the message analyzer 48 may process different types of messages from the platform software 16, such as a successful boot message sent by the platform software 16 or underlying component after a successful boot of the platform software 16.

The message analyzer 48 may also process a blue screen of death (BSOD) condition detection message sent by the platform software 16 or an interrupt handler when a BSOD condition is detected. In addition, the message analyzer 48 may detect an platform software package update, which may include a message sent by a package manager, the platform software 16, or any other suitable component after the update of the platform software 16 has been executed. The operating system package update message may contain information related to a product identifier (ID), a version of the platform software 16, recovery scripts for the associated platform software 16 identified in the product ID, and the like. As such, the message analyzer 48 may provide the BMC 12 with a dynamic mechanism to register a recovery script corresponding to an update to the platform software 16. In this way, the message analyzer 48 may assist the BMC 12 to provide a flexible and scalable solutions complementing prepackaged static recovery commands associated with the original operating systems or versions prior to the updated. The message analyzer 48 may store the recovery operations received dynamically after the operating system package and override the preconfigured recovery commands associated with the corresponding operating systems.

In some implementations, the message analyzer 48 may store messages received from the platform software 16 related to certain software components, associated with recovery scripts, and other information received via messages from the communication interface 18 in the recovery knowledge database 46. The stored information may include time stamps for updated software components, product IDs for updated software components, recovery scripts related to certain updates, and the like.

The recovery knowledge database 46 may be any suitable database or storage component that may be part of the circuitry of the BMC 12, separately connected to the BMC 12, and the like. In some implementations, the recovery knowledge database 46 may include information related to a current state of the platform software 16, as well as a series of journal entries indicative of software updates performed on the platform software 16, various software components, and the like. The journal entries may be derived by the message analyzer 48 using the messages sent from the platform software 16 after an operating system package or software update is received by the platform software 16. For example, if the platform software 16 performs a software update within a boot window for a security software component, the platform software 16 may send a message with data including a product ID associated with the software component being updated, a time in which the update occurred, a time at which the update was received by the platform software 16, and the like. The message analyzer 48 may extract this data from the message and store the corresponding information in the recovery knowledge database 46 as an entry in the journal. Based on the information stored in the recovery knowledge database 46, the recovery orchestrator 42 or other suitable component may use the stored information to determine recovery actions for recovering from a boot failure event or other event that may render the computing device 14 inaccessible. For example, in response to detecting a boot failure event (e.g., BSOD) after a package update, the recovery orchestrator 42 may retrieve the information stored in the journal within the recovery knowledge database 46 to determine or identify recovery scripts to execute. After executing the recovery scripts, the recovery orchestrator may return the affected software component to a previous state, remove the affected software component, or perform other suitable actions to assist the computing device 14 to resume operations or recover from the event.

In some implementations, the recovery knowledge database 46 may include a reference to a location that corresponds to a recovery image associated with the recovery operations for the platform software 16, a software component, and the like. The location may correspond to a network address or a storage location associated with the database 36 or the embedded storage 44. The recovery image may be mounted, and recovery scripts may be executed via the mounted recovery image to perform the recovery operations, which may include removing a software component, undoing changes implemented via a software update, returning the platform software 16 or a software component to a previous version, and the like.

Prior to querying the recovery knowledge database 46 for recovery operations, the boot failure detection engine 40 may detect boot failure events and other types of events that may cause the computing device 14 to become inoperable. As discussed above, the boot failure detection engine 40 may be enabled by the analysis of messages and commands sent from the platform software 16 or interrupt handlers via the communication interface 18 or other suitable communication channels.

If the boot failure event occurs in the UEFI stack, the boot failure detection engine 40 may use messages from the UEFI stack to determine an error state of the booting process. In some implementations, the boot failure detection engine 40 may analyze the messages and commands based on information provided by the message analyzer 48. That is, the message analyzer 48 may parse the messages received from the platform software 16 (e.g., the operating system or the UEFI stack) or the like to detect error events that correspond to the platform software 16 being unable to execute, the computing device 14 being unable to access IO devices, software components being inoperable, and the like. In addition, the message analyzer 48 may provide an indication related to a list of software updates performed over a period of time. Based on the information provided by the message analyzer 48, the boot failure detection engine 40 may map results of the analysis, such as a time and product ID of a software update, to a detected error (e.g., boot failure event). The boot failure detection engine 40 may store the mapping in the recovery knowledge database 46.

The boot failure detection engine 40 may be configured to evaluate potential events using policies that analyze properties associated with the detected event with respect to certain thresholds, time windows, and other corresponding circumstances to reduce the detection of false positives. The threshold-based detection techniques may assist the boot failure detection engine 40 to more accurately detect certain events, such as a boot failure condition. For example, the boot failure detection engine 40 may detect an event in response to determining that the platform software 16 has not sent a message after a threshold amount of time has expired since a previous message was detected. In another example, the boot failure detection engine 40 may be configured to automatically initiate a reboot in response to detecting a threshold value of two events with a 15-minute time detection window. After rebooting, the boot failure detection engine 40 may continue to monitor for the threshold condition to be met to ensure that the errors are resolved. If the threshold condition occurs again, the boot failure detection engine 40 may initiate a recovery action via the recovery orchestrator 42 or the like. In some implementations, the boot failure detection engine 40 may also send alerts associated with the detected states to external manageability applications that may include the computing systems 38 or the like.

After detecting a boot failure event preventing the computing device 14 or other software component from booting or initializing, the boot failure detection engine 40 may invoke application programming interfaces (APIs) of the recovery orchestrator 42 to initiate a recovery operation associated with the detected event. The recovery orchestrator 42 may be responsible for recovering the computing device 14 after the boot failure detection engine 40 detects a boot failure event. In some implementations, the recovery orchestrator 42 may be configured at deployment time with information related to a location of a recovery image for the platform software 16, other software components, or the like. That is, the location of the recovery image may include the embedded storage 44, the database 36, or any suitable storage component accessible to the recovery orchestrator 42.

The recovery orchestrator 42 may receive a message from the boot failure detection engine 40 to initiate a recovery operation based on information in the recovery knowledge database 46. As mentioned above, based on the type of event detected by the boot failure detection engine 40, the recovery knowledge database 46 may include corresponding recovery scripts to execute to resolve the event and return the platform software 16 or the computing device 14 to an operational state. For example, in response to determining that the boot failure event is due to a UEFI firmware update, the recovery orchestrator 42 may query the recovery knowledge database 46 to identify a version of the UEFI firmware prior to the update based on related journal entries. The recovery orchestrator 42 may then update the UEFI firmware using the previous version, which may be stored in the embedded storage 44 or any other suitable storage component.

If the recovery orchestrator 42 determines that the cause of the boot failure event is due to an update to the platform software 16, as part of the recovery operation, the recovery orchestrator 42 may obtain a backup of the current boot order configuration. The backup boot order configuration may be stored in the recovery knowledge database 46, which may store the journal entries of previous boot order configurations over time. Based on the backup boot order configuration, the recovery orchestrator 42 may automatically retrieve a recovery image that corresponds to the backup boot order configuration from a suitable storage component, such as the embedded storage 44, the database 36, and the like. The recovery orchestrator 42 may then mount the recovery image as a primary boot image for the BMC 12 to enable the computing device 14, the platform software 16, or other software component to boot.

In addition to retrieving the recovery image, the recovery orchestrator 42 may retrieve recovery scripts or instructions from the recovery knowledge database 46. In some implementations, recovery scripts for various types of boot failure events may be received by the message analyzer 48 over time and stored in the recovery knowledge database 46 for future reference in response to detecting the related event. If the recovery knowledge database 46 includes recovery scripts related to the update to the platform software 16, the recovery orchestrator 42 may initiate the recovery by executing the specified recovery scripts that may undo changes made to the platform software 16 by the recent update.

In some implementations, after receiving the recovery scripts associated with any particular recovery image, the recovery orchestrator 42 may inject the recovery scripts into the preconfigured recovery image as system-initiated scripts. The recovery orchestrator 42 may inject the system-initiated scripts in the recovery image by modifying portions of the recovery image. As a result, the system-initiated scripts may be incorporated into the recovery image when the recovery image is stored in the suitable storage and before the recovery image is mounted (e.g., via VMEDIA). In this way, the recovery orchestrator 42 may automatically execute the system-initiated scripts via the recovery image without accessing the recovery knowledge database 46.

It should be noted that if the boot failure occurred due to some update to the UEFI firmware, the recovery orchestrator 42 may retrieve another version of the corresponding software based on a corresponding recovery image. The recovery orchestrator 42 may also initiate the complete execution of the recovery commands a UEFI environment by using Extensible Firmware Interface (EFI) drivers and EFI applications.

After the recovery orchestrator 42 has executed the recovery scripts and determines that the recovery operations are complete, the recovery orchestrator 42 may restore the boot order to a previous configuration and reboot the platform software 16. In some implementations, the recovery orchestrator 42 may send alerts indicative of states of different recovery operations to external manageability applications, which may be part of the computing systems 38. In this way, the external manageability applications may have up-to-date information related to the operational status of the computing device 14 and any related recovery efforts.

To provide improved boot failure event detection features, the platform software 16 may include certain components to assist the performance of the techniques described herein. By way of example, FIG. 3 illustrates an operating system 20, which may correspond to one type of platform software 16. As shown in FIG. 3, the operating system 20 may include an operating system processor 60, which may correspond to any suitable processing component as described above. The operating system processor 60 may execute the software components of the operating system 20 and coordinate the installation of software components on the operating system 20, the computing device 14, and the like. The operating system processor 60 may monitor the boot status of the operating system 20 and may send messages to the BMC 12 in response to detecting boot events, such as boot failure events and successful boot events. The boot event message may include an indication of a type of boot event (e.g., successful boot, boot failure event, BSOD), a time stamp associated with the boot event, and other relevant information that may enable the BMC 12 to detect and initiate the recovery operations associated with the boot event.

The operating system 20 may send messages to the BMC 12 via the communication interface 18 and a BMC-OS interface driver 62. The BMC-OS interface driver 62 may detect states of the operating system 20 as recorded by the operating system processor 60, messages generated by the operating system processor 60, and the like. The BMC-OS interface driver 62 may forward messages to the BMC 12 via the communication interface 18.

In addition to detecting boot events in the operating system 20, the operating system processor 60 may also receive data related to software packages 64, such as updates to certain software components managed by the operating system 20, executed by the computing device 14, and the like. The software packages 64 may be received from certain manufacturers or developers (e.g., computing systems 38) of software components installed on the computing device 14, the operating system 20, and the like. The software packages 64 may include recovery-related information for reversing processes undertaken by software components after being updated (e.g., by third party delivered components with kernel access). The recovery information may include a key-value pair containing the product ID identifying the software component and the recovery scripts that may be employed to handle or reverse changes that occur due to the update to the software component. By way of example, the recovery scripts may include executing commands to modify a configuration setting to disable the software component, executing commands to delete or modify a registry, execute commands to delete the software components, execute commands to initiate a rollback of the software package 64, and the like. For instance, the software package 64 received from a vendor (e.g., computing system 38) may include recovery information embedded as a package manifest file containing the product ID and recovery operations (e.g., including recovery scripts, recovery image) for the operating system 20. This package manifest file may be sent to the BMC 12 via the communication interface 18 by the operating system processor 60 after installing the software package 64, by the BMC-OS interface driver 62 after detecting the installation of the software package 64, by the operating system processor 60, and the like.

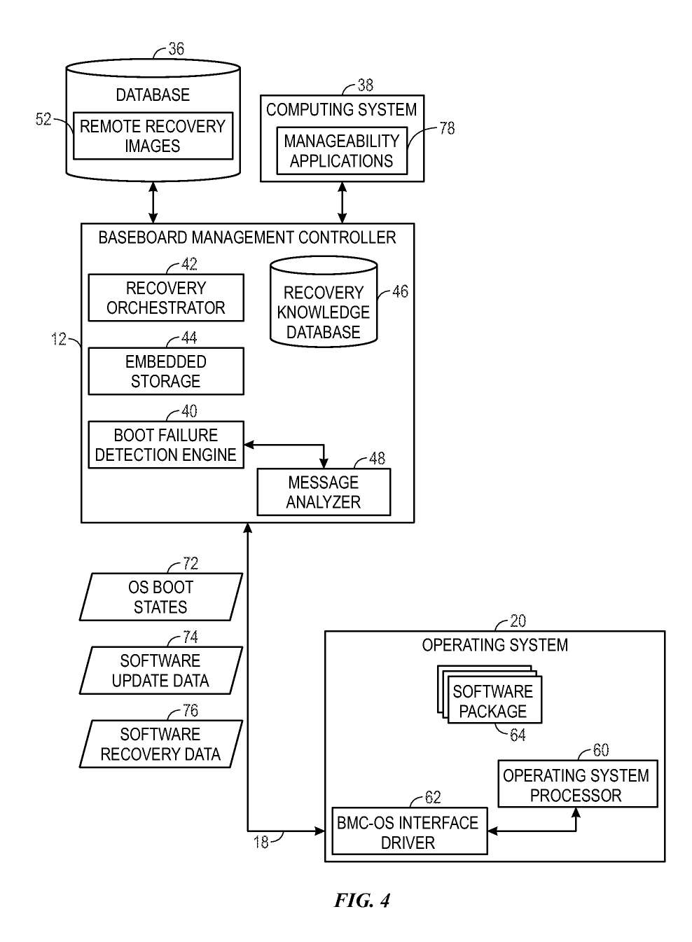

FIG. 4 illustrates the operating system 20 in communication with the BMC 12 in accordance with the techniques described herein. By way of operation, the operating system 20 may provide operating system (OS) boot states 72 corresponding to operational states of the operating system 20 at various times via the communication interface 18. In addition, after receiving software packages 64 for installation from the computing systems 38 or other devices, the operating system processor 60 may send software update data 74 related to times at which the software updates or installations were implemented, a product ID for the software component being updated or installed, and the like. The OS boot states 72 and the software update data 74 may be stored as part of journal entries within the recovery knowledge database 46 with respect to corresponding product IDs, as discussed above.

The operating system 20 may also send software recovery data 76 including recovery operations for the software component, recovery images for the software component, recovery scripts for undoing a software update or installation, and the like. The recovery images may include baseline versions of the software component, and the like. In some implementations, the operating system 20 may extract the software recovery data from the software packages 64 provided by vendors, third-parties, or the like. The software recovery data 76 may also include recovery scripts and recovery images for restoring the operating system 20 to a previous state or version. The software recovery data 76 may be stored in the recovery knowledge database 46 for retrieval by the recovery orchestrator 42 after the boot failure detection engine 40 detects a potential boot failure event as described above.

After receiving the OS boot states 72, the software update data 74, the software recovery data 76, and other datasets communicated via the communication interface 18 from the operating system 20, the message analyzer 48 may send corresponding datasets to the recovery knowledge database 46. The datasets may include key-value pairs as mentioned above, as well as a collection of information related to any particular software type, operating system update, software update, and the like. The recovery knowledge database 46 may maintain reference information related to the times at which software updates are implemented, recovery scripts for reversing updates, policies for detecting a boot failure event, recovery images for software components or operating systems, and other information for each product ID. In some implementations, the message analyzer 48 may process recovery scripts associated with the software update data 74, the software recovery data 76, and other messages received vis the communication interface 18. In some implementations, the message analyzer 48 may receive recovery images via the communication interface 18 and store the recovery images in the embedded storage 44, the database 36 as a remote recovery image 52, or in any other suitable storage.

After detecting the boot failure event based on messages analyzed by the message analyzer 48, the boot failure detection engine 40 may send an indication of the type of boot failure event detected to the recovery orchestrator 42. In turn, the recovery orchestrator 42 may query the recovery knowledge database 46 to determine recovery operations to perform in response to detecting the boot failure event. Based on the recovery operations associated with the type of boot failure event stored in the recovery knowledge database 46, the recovery orchestrator 42 may retrieve a recovery image from the embedded storage 44, the database 36, or other suitable storage component. In addition, the recovery orchestrator 42 may retrieve the recovery operations associated with restoring the computing device 14, the operating system 20, or the like due to the boot failure event. The recovery operations may specify a location of the recovery image to mount and execute, recovery scripts to incorporate into the recovery image, recovery commands to execute to recover from the detected boot failure event, and the like. After executing the recovery scripts (e.g., via the recovery image), the recovery orchestrator 42 may reboot the operating system 20, and the message analyzer 48 may confirm that the operating system 20 has booted successfully based on messages received from the operating system 20. In some implementations, the recovery orchestrator 42 may provide status updates regarding the recovery operations to management applications 78 that may be part of the computing system 38.

Although the recovery orchestrator 42, the boot failure detection engine 40, the message analyzer 48, and other components mentioned herein are described as individual components, it should be noted that each of these components may be combined with various other components to perform the functions therein. In addition, each of these components may be implemented via hardware (e.g., electronic circuitry) or a combination of hardware and programming (the combination comprising, e.g., at least one processor and instructions executable by the at least one processor and stored on at least one machine-readable storage medium).

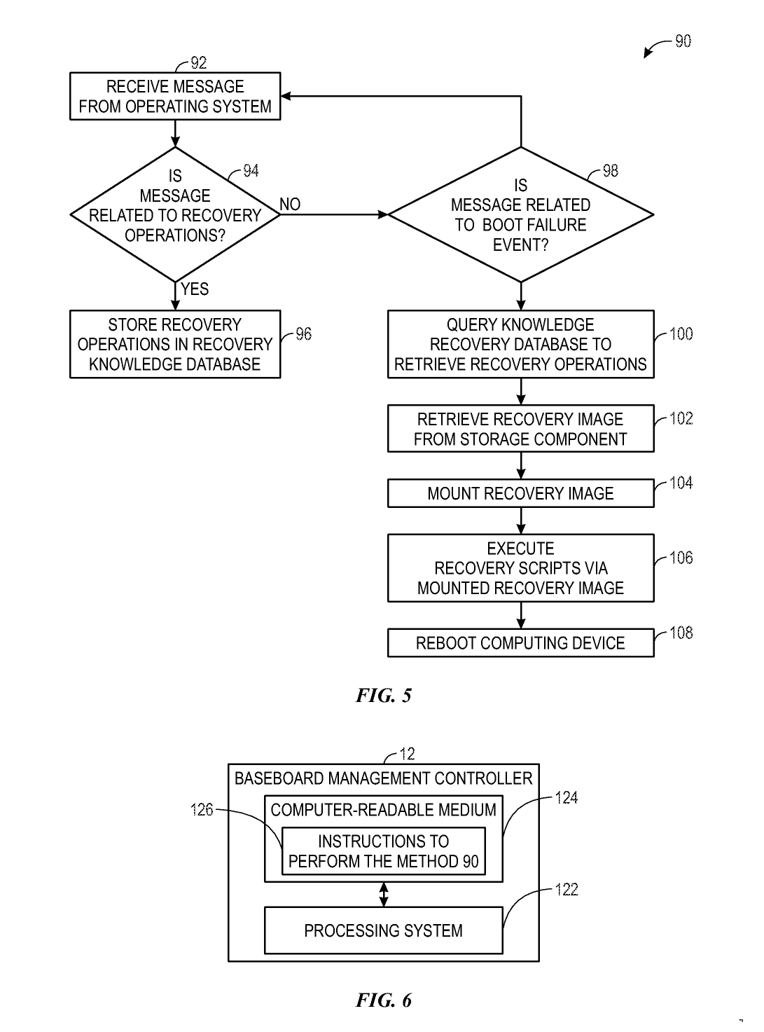

FIG. 5 illustrates an example flow chart of a method 90 for performing recovery operations in response to detecting a boot failure event, in accordance with techniques described herein. Although the following description of the method 90 is discussed as being performed by the BMC 12, it should be noted that the method 90 may be performed by a variety of components that make up the BMC 12 as detailed above. Moreover, it should be understood that the method 90 may be performed by any suitable processing system with access to the datasets described herein. Further, although the method 90 is described as being performed in a particular order, it should be understood that the method 90 may be performed in any suitable order.

Referring now to FIG. 5, at block 92, the BMC 12 may receive a message from the operating system 20. The message may include the operating system boot states 72, the software update data 74, the software recovery data 76, and the like. In some implementations, the operating system 20 may send periodic updates to the BMC 12 indicative of its current operational state and certain tasks that the operating system 20 may have completed.

At block 94, the BMC 12 may determine whether the message is related to recovery operations. That is, some messages may include information related to recovering from boot failure events that occur due to faulty updates to the operating system 20, faulty updates to a software component being executed by the computing device 14, and the like. The message may also include information related to changes implemented by the operating system 20 in response to receiving an update.

If the BMC 12 determines that the message is related to recovery operations, the BMC 12 may proceed to block 94 and store the recovery operations in the recovery knowledge database 46. As discussed above, the recovery knowledge database 46 may include a set of recovery operations for different types of boot events, such as boot failure events, software failure events, and the like. The recovery knowledge database 46 may be organized according to different product IDs that correspond to different types of operating systems, different types of software components, and the like.

The set of recovery operations stored in the recovery knowledge database 46 may include related data and/or instructions for recovering from a respective event. As such, the set of recovery operations may include a location of a recovery image for restoring the operating system 20, a software component, or the like from the boot event. In some implementations, the message may include the recovery image or a network location to retrieve the recovery image. The recovery image may be stored in the recovery knowledge database 46, the embedded storage 44, the database 36, or the like.

The recovery knowledge database 46 may include journal entries related to the types of updates performed by the operating system 20, the product IDs of the software components updated, the times at which the software components were updated, and the like. Based on the journal entries, the BMC 12 may determine previous versions or states of the operating system 20 or software components to return to in response to detecting a boot event.

Referring back to block 94, if the BMC 12 determines that the message is not related to recovery operations, the BMC 12 may proceed to block 98. At block 98, the BMC 12 may determine whether the message is related to a boot failure event. If the message is unrelated to a boot failure event or any other event, the BMC 12 may return to block return to block 92 and continue receiving messages from the operating system 20.

However, if the message from the operating system 20 is indicative of the operating system 20 not being able to boot, the BMC 12 may proceed to block 100. In some implementations, the BMC 12 may determine that a boot failure event is present when a message is indicative of a boot failure. In addition, the BMC 12 may detect a boot failure event based on the absence of a message (e.g., successful boot, status signal, heartbeat signal) being received from the operating system 20 within a certain time period. In the same manner, if the BMC 12 fails to receive an expected message from the operating system 20, the BMC 12 may determine that a boot failure event has occurred.

In addition to detecting a boot failure event, the BMC 12 may detect a software component failure or error based on the message received from the operating system 20. That is, the operating system 20 may implement an update to a software component and determine that the software component has become inaccessible or unresponsive after implementing the update. As such, the operating system 20 may send a message to the BMC 12 indicative of the software component error.

In some implementations, the BMC 12 may detect a boot failure event based on an analysis of image data or pixels displayed on the display 32. That is, if the image data correspond to an error state, such as a lack of images being presented, a BSOD condition, or the like, the BMC 12 may determine that a boot failure event is present.

After detecting a boot failure event or a software component error, the BMC 12 may proceed to block 100 and query the recovery knowledge database 46 to retrieve recovery operations associated with the detected event. The BMC 12 may query the recovery knowledge database 46 based on a product ID identified in the message. The recovery knowledge database 46 may include information related to the last known time of an update to the associated product, a location of a recovery image, one or more recovery scripts to execute for recovery operations, and the like.

At block 102, the BMC 12 may retrieve the recovery image from the storage component specified in the recovery knowledge database 46. As discussed above, the recovery image may be stored in the embedded storage 44, the database 36, or any other suitable storage component accessible to the BMC 12. The recovery image may include previous settings of the operating system 20, applications available to the operating system 20, user data stored with the operating system 20, and other features of the operating system 20 at a particular time.

After retrieving the recovery image, at block 104, the BMC 12 may mount the recovery image to a hard drive, a virtual hard drive, or the like, such that the operating system 20 may access the recovery image. The BMC 12 may then, at block 106, execute recovery scripts based on the recovery image to return the operating system 20 or other software component to a previous state associated with the recovery image.

By executing the recovery scripts, the BMC 12 may perform the recovery operations involved in returning the operating system 20, the software component, or the like to a previous state prior to the detection of the boot failure event or other event. After executing the recovery scripts, the BMC 12 may proceed to block 108 and reboot the computing device 14 to confirm that the boot failure event has been resolved and that the computing device 14 is operable.

FIG. 6 illustrates components of the BMC 12 that may include a processing system 122 and computer-readable medium 124 that may store computer-readable instructions 126 that may cause the processing system 122 to perform the method 90 described above. The processing system 122 may include one or more hardware processors, one or more processing cores, or one or more processing units, such as the processing units 24 described above. In addition, the computer-readable medium 124 may correspond to a storage component, such as the storage component 28 described above. In some implementations, the processing system 122 may execute the computer-readable instructions 126 to cause the processing system 122 to perform the method 90 or portions thereof.

As may be appreciated, the current techniques provide a methodology to automatically detect and recover from boot failure events using the BMC 12 or other suitable on-board circuitry. As such, recovery operations avoid waiting for on-site access by personnel to perform recovery operations for computing devices. Indeed, the present techniques provide a flexible approach to continuously update a recovery knowledge database to update recovery operations that may be employed to recover from different types of boot failure events, software component errors, and the like. As a result, affected computing devices may return to an operational state in an efficient manner, while improving the cyber-resiliency of the devices.

While only certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. A tangible, non-transitory, computer-readable medium, comprising computer-readable instructions that, when executed by a processing system, cause the processing system to:
detect a boot failure event associated with a computing device based on one or more messages received from a platform software;
query a database to identify a set of recovery operations based on the boot failure event, wherein the database comprises one or more recovery operations associated with each of a plurality of boot failure events, wherein the set of recovery operations comprises:
an indication of a storage location of an image for restoring the computing device; and
one or more scripts for restoring the computing device;
retrieve, based on the storage location, the image from a storage;
execute the one or more scripts; and
initiate a boot operation for the computing device after the one or more scripts are executed.

2. The tangible, non-transitory, computer-readable medium of claim 1, wherein the computer-readable instructions cause the processing system to:
receive an update to a software application associated with the computing device, wherein the update comprises one or more additional recovery scripts associated with the software application;
storing information associated with the update and the one or more additional recovery scripts in the database;
retrieving the one or more additional recovery scripts stored in database in response to detecting a failure associated with the software application; and
executing the one or more additional recovery scripts.

3. The tangible, non-transitory, computer-readable medium of claim 1, wherein the computer-readable instructions cause the processing system to:
incorporate the one or more scripts into the image;
mount the image for access by the processing system; and
execute the one or more scripts via the image.

4. The tangible, non-transitory, computer-readable medium of claim 1, wherein the computer-readable instructions cause the processing system to detect the boot failure event based on a plurality of pixels displayed via a display associated with the processing system.

5. The tangible, non-transitory, computer-readable medium of claim 1, wherein the platform software includes an operating system, and wherein the database comprises a journal indicative of one or more updates performed on the operating system, one or more software applications associated with the computing device, or both.

6. The tangible, non-transitory, computer-readable medium of claim 5, wherein the computer-readable instructions cause the processing system to:
identify a previous boot order configuration based on the journal of entries; and
retrieve the image associated with the previous boot order configuration.

7. The tangible, non-transitory, computer-readable medium of claim 1, wherein the computer-readable instructions cause the processing system to:
retrieve a policy associated with implementing the set of recovery operations based on a type of the boot failure event from the database; and
execute the one or more scripts based on the policy, wherein the platform software includes an operating system, wherein the policy comprises restoring the operating system to a previous state or restoring a software component associated with the computing device to an additional previous state.

8. The tangible, non-transitory, computer-readable medium of claim 7, wherein the previous state corresponds to a default state of the operating system, and wherein the additional previous state corresponds to a state of the computing device on at a time.

9. The tangible, non-transitory, computer-readable medium of claim 1, wherein the computer-readable instructions cause the processing system to detect the boot failure event based on an absence of receiving the one or more messages from the platform software within a period of time.

10. The tangible, non-transitory, computer-readable medium of claim 1, wherein the platform software comprises a Linux operating system.

11. The tangible, non-transitory, computer-readable medium of claim 1, wherein the platform software includes a Unified Extensible Firmware Interface (UEFI) stack of the computing device, and wherein the computer-readable instructions cause the processing system to detect the boot failure event corresponding to one or more errors sent from the Unified Extensible Firmware Interface (UEFI) stack.

12. A system, comprising:
a database comprising one or more recovery operations associated with each of a plurality of boot failure events;
a platform software;
a baseboard management controller configured to:
receive one or more messages from the platform software;
detect a boot failure event associated with a computing device associated with the platform software based on the one or more messages;
query the database to identify one or more scripts from a set of recovery operations associated with the boot failure event;
retrieve an image from a storage component based on the set of recovery operations; and
execute the one or more scripts, wherein the one or more scripts are configured to return the platform software to a previous state.

13. The system of claim 12, wherein the one or more messages are indicative of one or more corresponding states of one or more instances of booting the platform software.

14. The system of claim 12, wherein the baseboard management controller is configured to:
receive a software package configured to update a software application executed by the computing device; and
update the database with one or more additional recovery operations associated with the update of the software application based on the software package.

15. The system of claim 12, wherein the boot failure event corresponds to at least one of a blue screen of death (BSOD) event, a continuous BSOD state, and a boot process failure in a Unified Extensible Firmware Interface (UEFI) stack.

16. The system of claim 12, wherein the storage component comprises an embedded storage component associated with the baseboard management controller.

17. A method, comprising:
detecting, via a controller, a boot failure event associated with a computing device;
querying, via the controller, a database to identify a set of recovery operations comprising one or more scripts associated with recovering from the boot failure event, wherein the database comprises a plurality of sets of recovery operations associated with a plurality of boot failure events;
retrieving, via the controller, an image based on the set of recovery operations; and
executing, via the controller, the one or more scripts, wherein the one or more scripts are configured to return the computing device to a previous state.

18. The method of claim 17, comprising:
receiving, via the controller, one or more messages from a platform software of the computing device; and
detecting, via the controller, the boot failure event based on the one or more messages.

19. The method of claim 17, comprising:
receiving, via the controller, one or more messages from a platform software of the computing device, wherein the one or more messages comprise a date associated with a successful boot, wherein the one or more scripts are configured to return the computing device to the previous state based on the date.

20. The method of claim 17, wherein the platform software includes a Unified Extensible Firmware Interface (UEFI) stack of the computing device, and wherein the method further comprises:
receiving, via the controller, one or more messages from the Unified Extensible Firmware Interface (UEFI) stack; and
detecting, via the controller, the boot failure event based on the one or more messages.
